(19) United States
(12) Patent Application Publication
(10) Pub. No.: US 2025/0284951 A1
(43) Pub. Date: Sep. 11, 2025

(54) NEURAL NETWORK SYSTEM, FLOATING POINT NUMBER PROCESSING METHOD AND DEVICE

(71) Applicant: MACRONIX INTERNATIONAL CO., LTD., Hsinchu (TW)

(72) Inventors: Yi-Hao JHU, Hsinchu City (TW); Shih-Hung CHEN, Hsinchu County (TW)

(21) Appl. No.: 18/595,702

(22) Filed: Mar. 5, 2024

(51) Int. Cl. G06N 3/08

(52) U.S. Cl. CPC G06N 3/08

(57) ABSTRACT

The application discloses a neural network system, a method, and a device for processing floating-point number. A self-defined floating-point number is obtained, wherein the self-defined floating-point number comprises a sign field, an exponent field, and a mantissa field, and a value of the self-defined floating-point number is determined by bit of the sign field, bits of the exponent field, bits of the mantissa field, and a bias value, wherein the bias value is determined by a total bit number of the exponent field. The self-defined floating-point number is applied to numerical calculations.

### TECHNICAL FIELD

The disclosure relates in general to a neural network system, a method, and a device for processing floating-point number. In particular, it pertains to a neural network system, a method, and a device compatible with a self-defined floating-point number format.

### BACKGROUND

With the rise of Artificial Intelligence (AI) technology, particularly models based on neural networks, there has been a shift in computational requirements. This transformation has moved computational demands away from the Central Processing Unit (CPU) and towards new processors such as Graphic Processing Unit (GPU), Tensor Processing Unit (TPU), Neural-network Processing Unit (NPU), or Field Programmable Gate Array (FPGA).

These new processors significantly differ from traditional CPUs in terms of memory requirements, as evidenced by the following aspects.
(1) Less emphasis on latency: This indicates that these new processors are relatively insensitive to delays in the computation process, possibly prioritizing overall computational efficiency.
(2) High regard for memory bandwidth: The processors places greater importance on memory transfer rates to ensure efficient data access.
(3) Larger capacity requirements: New processors demand larger memory capacities, possibly due to handling large amounts of data or complex models that require more memory space.
(4) Higher efficiency requirements: This signifies that these processors focus more on efficiently completing computational tasks to improve energy utilization.

In comparison to traditional CPUs and Dynamic Random Access Memory (DRAM) combinations, memory solutions for new processors often involve GPUs paired with Graphics Double Data Rate (GDDR) or High Bandwidth Memory (HBM). These solutions typically place both on graphics cards to reduce data transfer distance and energy consumption. Specifically, GDDR provides high bandwidth but limited capacity, while HBM offers both higher bandwidth and larger capacity than GDDR.

The mentioned memory solutions (GPU with GDDR or GPU with HBM) are relatively expensive. Meanwhile, as the size of large language models (LLM) is exponentially increasing, indicating that models are becoming more massive and requiring processing of more data and parameters. Therefore, the demand for higher-capacity memory in the field of artificial intelligence becomes more urgent. In summary, with technological advancements and the growth of model scales, more advanced and extensive memory is needed to meet the requirements of AI applications.

In recent years, to meet specific application needs, several new memory concepts have been developed, including: (1) DRAM directly integrated with logic chips with ultra-wide I/O for extremely high bandwidth without the high cost of Through-Silicon Via (TSV); (2) Integration of logic, DRAM, and volatile NAND for extremely high capacity; and (3) Continued miniaturization to push the limits of memory to higher levels.

However, these solutions are to some extent affected by concerns about memory reliability, manifested as: (1) DRAM and logic chips occupying large areas, making it challenging to ensure error-free operation; (2) Rare occurrence of a naturally flawless NAND manufacturing process; and (3) Increased error rates due to miniaturization.

While reliability issues can be addressed by adding additional controllers, this not only increases costs but also introduces noticeable delays.

Therefore, the objective of this patent is to provide a method for reducing the impact of memory errors and achieving Computing In Memory (CIM) tailored for artificial intelligence applications.

### SUMMARY

According to one embodiment, a neural network system is provided. The neural network system comprises one or more memory devices, wherein the one or more memory devices store one or more neural network models, and when training the one or more neural network models, the one or more memory devices executing: initiating weight training iterations; determining whether an abnormal weight is detected; when the abnormal weight is detected, setting the abnormal weight to a reference value; and when no abnormal weights are detected, proceeding to the next training iteration.

According to another embodiment, a floating-point processing method applied to an electronic device is provided. The floating-point processing method comprises: obtaining a self-defined floating-point number, wherein the self-defined floating-point number comprises a sign field, an exponent field, and a mantissa field, and a value of the self-defined floating-point number is determined by bit of the sign field, bits of the exponent field, bits of the mantissa field, and a bias value, wherein the bias value is determined by a total bit number of the exponent field; and applying the self-defined floating-point number to numerical calculations.

According to an alternative embodiment, a floating-point processing device comprising a processor is provided. The processor executes: obtaining a self-defined floating-point number, wherein the self-defined floating-point number comprises a sign field, an exponent field, and a mantissa field, and a value of the self-defined floating-point number is determined by bit of the sign field, bits of the exponent field, bits of the mantissa field, and a bias value, wherein the bias value is determined by a total bit number of the exponent field; and applying the self-defined floating-point number to numerical calculations.

### BRIEF DESCRIPTION OF THE DRAWINGS

FIG. 1A illustrates a schematic diagram of a neural network (NN).

FIG. 1B shows the accuracy of the neural network during the training phase.

FIGS. 2A to 2D display the weight distribution after successful training, using different model sizes and databases. Each distribution has undergone normalization for fair comparison.

FIG. 3 illustrates the training process of the fault-tolerant training (FTT) in one embodiment of the application.

FIG. 4 shows the results of the error simulation experiment in one embodiment.

FIG. 5 illustrates the Fault-tolerant Floating Point (FTF) format in another embodiment.

FIG. 6 compares the FTF16 format in one embodiment of the application with a known self-defined floating-point format under errors in exponent bits.

FIG. 7 illustrates the Fault-tolerant Floating Point (FTF) format in another embodiment of the application.

FIG. 8 illustrates another embodiment of the Fault-tolerant Floating Point (FTF) format in the application.

FIG. 9 depicts another Fault-tolerant Floating Point (FTF) format in one embodiment of the application.

FIG. 10 illustrates an example of a neural network processing system based on one embodiment of the present application.

FIG. 11 is a schematic diagram of a system architecture provided in one embodiment of the application.

FIG. 12 is a schematic diagram of the structure of an electronic device provided in one embodiment of the application.

FIG. 13 illustrates a floating-point processing method applied to an electronic device according to one embodiment of the application.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DESCRIPTION OF THE EMBODIMENTS

Technical terms of the disclosure are based on general definition in the technical field of the disclosure. If the disclosure describes or explains one or some terms, definition of the terms is based on the description or explanation of the disclosure. Each of the disclosed embodiments has one or more technical features. In possible implementation, one skilled person in the art would selectively implement part or all technical features of any embodiment of the disclosure or selectively combine part or all technical features of the embodiments of the disclosure.

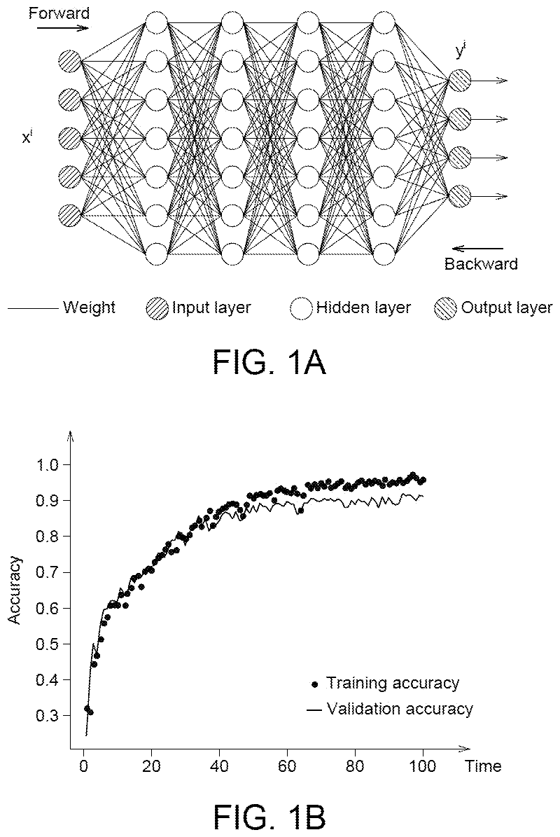

FIG. 1A illustrates a schematic diagram of a neural network (NN), while FIG. 1B shows the accuracy of the neural network during the training phase.

Now, the basic structure and training of a neural network are described. A neural network employs one or more layers of nonlinear units to predict outputs based on received inputs by a series of computations, constituting a machine learning model. Apart from the input layer and the output layer, a neural network includes one or more hidden layers. The output of each hidden layer serves as the input for the next layer (either another hidden layer or the output layer). Each layer in the neural network generates output values from received input values based on its current parameters (weight values).

The neural network is represented as a function, denoted as f_{w}(xⁱ)=yⁱ, where the set of trainable weight w maps the input vector xⁱ to the output vector yⁱ.

The neural network structure has a layered architecture, as shown in FIG. 1A. The first layer is the input layer, containing the components of the input vector xⁱ, where xⁱ=(x₁ⁱ, x₂ⁱ, . . . , x_{N}ⁱ). The last layer is the output layer, containing the output vector of the neural network, yⁱ=(y₁ⁱ, y₂ⁱ, . . . , y_{M}ⁱ). The hidden layers between the input and output layers extract features from the input vector xⁱ. The connections between the input and hidden layers, between hidden layers, between hidden layers and the output layer, represent trainable weights w.

The training accuracy of the neural network is depicted in FIG. 1B. The neural network's initial accuracy is poor before training. The goal of training is to find an optimal set of weights w^{o} that makes the neural network's outputs yⁱ best match the expected answers ŷⁱ for the corresponding inputs xⁱ. Throughout training, by adjusting weights, the neural network gradually improves its accuracy, becoming proficient at executing the given tasks.

The rapid increase in training costs for artificial intelligence (AI) models and the introduction of self-defined floating-point formats to accelerate AI applications are described.

The training costs for developing AI models have rapidly increased over their development. This indicates that as models advance, the costs required for training become higher.

As AI model operations involve floating-point computations, various self-defined floating-point formats have emerged to accelerate AI applications. These self-defined floating-point formats may be optimized for specific application scenarios to enhance computational efficiency. For example, there are proposed industry-specific memories designed for specific self-defined floating-point format operations, embedding accelerators for executing operations in that format. This is aimed at more efficiently supporting AI applications.

However, these methods are not designed to handle faulty operations. In other words, they may lack the capability to deal with errors in operations. Therefore, these methods are not suitable for the context of computing in memory (CIM).

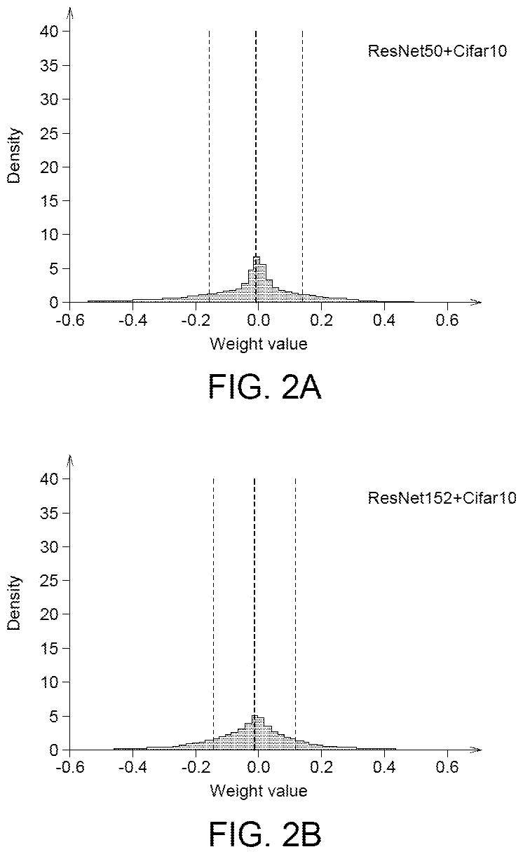

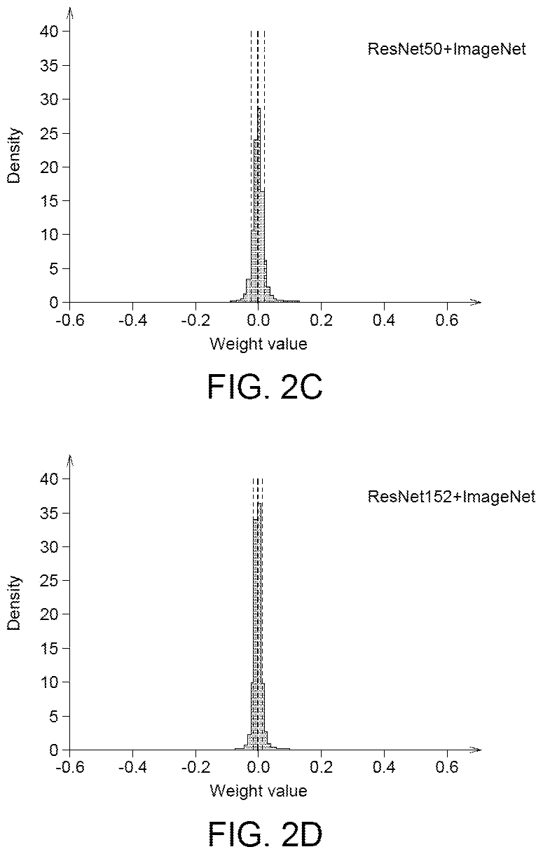

The invention is based on the observation of two characteristics of the weight distribution shown in FIGS. 2A to 2D: the range and the center of the weight distribution. FIGS. 2A to 2D display the weight distribution after successful training, using different model sizes and databases. Each distribution has undergone normalization for fair comparison.

Regarding the weight range, as shown in FIGS. 2A to 2D, each weight distribution is within the range (−1,1), indicating that all weights are constrained within the range (−1,1).

Concerning the center of the weight distribution, as shown in FIGS. 2A to 2D, the center of each weight distribution is approximately near zero, suggesting that most weights are concentrated around zero, indicating sparsity, a common characteristic in machine learning and neural network models.

Now, a new training method inspired by the observation of the weight distribution is explained and a solution for potential errors in the computing in memory (CIM) process is proposed.

Based on the observation of the weight distribution, after training, weights typically fall within the range (−1,1), and most weights are almost zero. This implies that the weights exhibit a certain level of sparsity and are concentrated around zero in the model.

One embodiment of the invention introduces a fault-tolerant training (FTT) method. When adopting the CIM architecture, errors may occur during the acceleration of the training process. To address this, the embodiment proposes a new training procedure called fault-tolerant training (FTT). In FTT, trained weights which are beyond the normal range are considered abnormal weights, and these abnormal weights are set to zero or another reference value throughout the training process.

Experimental results show that, in some cases, setting abnormal weights to zero does not compromise accuracy and may even enhance.

Additionally, another embodiment proposes a new self-defined floating-point format: the fault-tolerant floating point (FTF) format.

Existing self-defined floating-point formats, while accelerating AI operations, are generally designed to cover a wide range of numerical values. However, existing self-defined floating-point formats may not be designed to handle errors in the exponent bits, which can severely impact the numerical values.

Therefore, another embodiment introduces a new self-defined floating-point format called the fault-tolerant floating point (FTF) format. The value range of the FTF format is smaller (ranging between (−1,1) or other small value ranges), making more effective use of each bit in the fault-tolerant floating point (FTF) format and significantly reducing negative effects due to bit errors.

### Fault-Tolerant Training (FTT) Embodiment:

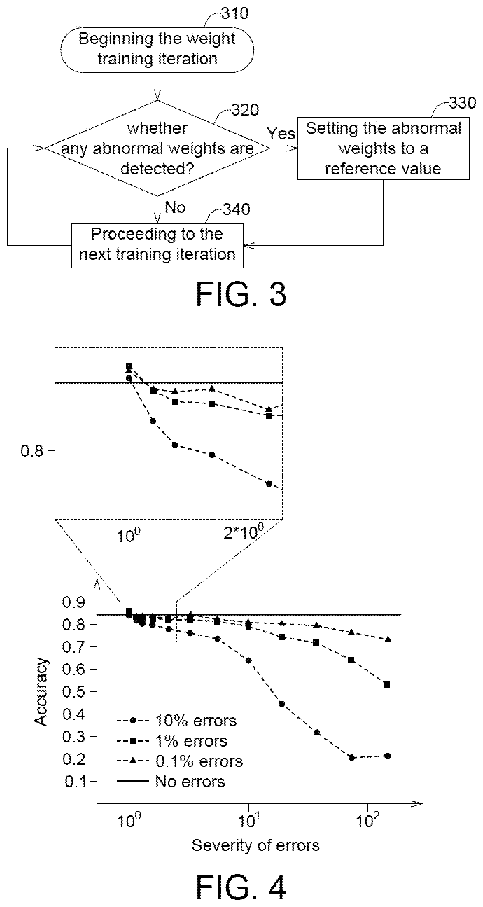

FIG. 3 illustrates the training process of the fault-tolerant training (FTT) in one embodiment of the application. FTT involves modifications to the training process, adjusting the existing training flow to handle potential anomalies. The training process of fault-tolerant training (FTT) in FIG. 3 can be executed by hardware or software. For example, the training process of fault-tolerant training (FTT) can be executed by a computer system or a floating-point computation chip.

In step 310, the weight training iteration begins.

In step 320, it is determined whether any abnormal weights are detected. The purpose of step 320 is to identify errors or abnormal weights that may occur during the training of weights (e.g., weights of a neural network model) in the CIM architecture. If there are hardware defects (such as defects in memory chips) when adopting the CIM architecture, errors (such as bit errors) may occur during the neural network training process.

If, in step 320, any abnormal weights are found, step 330 sets these abnormal weights to a reference value. This approach aims to eliminate abnormal weights that may adversely affect the model, ensuring training stability and accuracy.

If, in step 320, no abnormal weights are found, step 340 proceeds to the next training iteration.

During the training iteration, in step 320, it can be chosen to check at least one of pre-update weights and updated weights to detect whether abnormal weights are introduced. Step 320 helps identify whether anomalies are introduced during the weight update process.

As for the definition of abnormal weights, in one embodiment, there can be multiple definitions of abnormal weights. For example, but not limited to, if a weight falls outside the range of the median plus or minus one or more standard deviations of normal weights, the weight is determined to be an abnormal weight. For example, but not limited to, if the median of normal weights is −0.0072, and the standard deviation of normal weights is 0.14748, then the range of the median plus or minus three times the standard deviation of normal weights is: −0.0072±3*0.1478, i.e., between −0.4506˜0.4362. Therefore, if the pre-update or post-update weight exceeds −0.4506˜0.4362, it is considered an abnormal weight. The median of normal weights is the median of all normal weights.

Alternatively, if a weight falls outside a value range (or said numerical range), it is considered an abnormal weight. The value range may include but is not limited to (−1, 1). In one embodiment, the value range depends on the self-defined floating-point format. The relationship between the value range and the self-defined floating-point format will be explained separately below.

In step 330, there can be various ways to set these abnormal weights to a reference value. For example, but not limited to, the median of normal weights is used as a reference value (i.e., setting abnormal weights to the “median of normal weights”). Alternatively, abnormal weights are set to zero (i.e., setting 0 as a reference value).

In summary, in one embodiment, these methods and choices provide flexibility in handling abnormal weights during the training process, ensuring the stability and accuracy of the model.

In one embodiment, experiments were conducted to determine whether fault-tolerant training could provide assistance. In the experiment, the RestNet50 model and the standard database Cifar10 were used for training. In this process, manual introduction of weight errors was done, and two metrics, error severity and the number of errors, were used to define these errors.

Error quantity: Fixing 10%, 1%, or 0.1% of the weights to a certain value. This simulates introducing different quantities of weight errors during the training process.

Error severity: The severity of errors is defined as follows: after training, in the absence of errors, and using the standard deviation σ=0.14 across all weights as the unit, the values of selected weights are fixed at 0, 1, 2, 4, 8, 16, 32, 64, 128, 256, 512, and 1024. The severity of errors can measure the degree of impact introduced errors have on the model and the magnitude of weight variations corresponding to the errors.

FIG. 4 shows the results of the error simulation experiment in one embodiment. The horizontal axis in FIG. 4 is presented on a logarithmic scale. To represent the severity of errors accurately, the error severity values on FIG. 4 must be subtracted by 1. However, this adjustment does not impact the overall generalization of results. From the results of the error simulation experiment in FIG. 4, the following points can be inferred:

For data having given accuracy (points on the horizontal lines): Data with higher severity errors also has lower error quantities. In other words, while maintaining the same level of accuracy, data can tolerate more severe errors as the quantity of errors decreases.

For data having a given error severity (points on the vertical lines): Data with higher accuracy also has lower error quantities. In short, for keeping the same error severity, higher error quantities, lower accuracy.

For data having a given error quantity (as indicated by dotted lines such as “0.1% error”): With a decrease in error severity, accuracy tends to increase.

In other words, when errors occur, by setting the severity of errors to the minimum value (setting weights to zero or a reference value), this can enhance accuracy and, consequently, correcting impact of errors on the model.

In summary, these summaries indicate the relationships between error quantity, severity, and accuracy under different conditions, indicating that fault-tolerant training (FTT) in one embodiment can maintain model performance when errors occur.

From the above, it can be concluded that the fault-tolerant training (FTT) in one embodiment can effectively reduce errors, addressing the unreliable issue in CIM operations, enabling CIM and accelerating AI computation.

### Fault-Tolerant Floating Point (FTF) Format:

Another embodiment introduces a new self-defined floating-point format called the Fault-tolerant Floating Point (FTF) format.

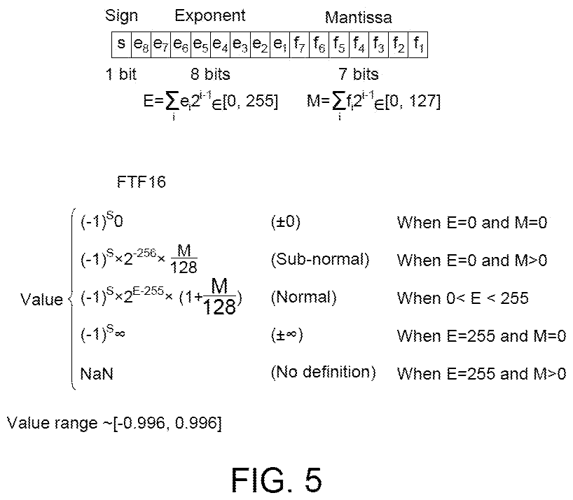

FIG. 5 illustrates the Fault-tolerant Floating Point (FTF) format in another embodiment. Here, the Fault-tolerant Floating Point (FTF) format is explained with 16 bit version (referred to as FTF16) as an example, but it is important to note that the application is not limited to this specific example.

The 16-bit version Fault-tolerant Floating Point (FTF) format includes a sign field (with a one sign bit s), an exponent field (with 8 exponent bits e₈-e₁), and a mantissa field (with 7 mantissa bits f₇-f₁).

Representing the 8 exponent bits in decimal as E (where E is referred to as the numerical value of the exponent field), E can be expressed as follows in Equation (1):

$$= {\sum }_{i = 1}^{8} {e}_{i} {2}^{i - 1} ∈ [ 0 , 255 ] \qquad ( 1 )$$

Representing the 7 mantissa bits in decimal as M (where M is referred to as the numerical value of the mantissa field), M can be expressed as follows in Equation (2):

$$M = {\sum }_{i = 1}^{7} {f}_{i} {2}^{i - 1} ∈ [ 0 , 127 ] \qquad ( 2 )$$

Therefore, the numerical value of FTF16 is calculated as follows.

When E=0 and M=0, FTF16 is given by FTF16=(−1)^{s}0. In this case, when the sign s=0, FTF16 is FTF16=(−1)⁰0=+0, and when s=1, FTF16 is FTF16=(−1)¹0=−0. Therefore, when E=0 and M=0, FTF16 is referred to as positive-negative zero (±0). Here, E=0 indicates that all exponent bits in the exponent field are 0, and M=0 indicates that all mantissa bits in the mantissa field are 0.

When E=0 and M>0, FTF16 is given by

$$FTF 16 = {( - 1 )}^{s} \times {2}^{- 256} \times \frac{M}{128} ,$$

and this is termed as a sub-normal value.

When 0<E<255 (regardless of the value of M), FTF16 is given by

$$FTF 16 = {( - 1 )}^{s} \times {2}^{E - 255} \times ( 1 + \frac{M}{128} ) ,$$

and this is termed as a normal value.

When E=255 and M=0, FTF16 is given by FTF16=(−1)^{s}∞, and this is termed as positive-negative infinity (to).

When E=255 and M>0, FTF16 is termed as a NaN (Not a Number).

Summarizing the above:

$$Value = \{ \begin{matrix}{( - 1 )}^{s} 0 ( \pm 0 ) when E = 0 and M = 0 \\ {( - 1 )}^{s} \times {2}^{- 256} \times \frac{M}{128} ( sub - normal ) when E = 0 and M > 0 \\ {( - 1 )}^{s} \times {2}^{E - 255} \times ( 1 + \frac{M}{128} ) ( nomal ) when 0 < E < 255 \\ {( - 1 )}^{s} ∞ ( \pm ∞ ) when E = 255 and M = 0 \\ NaN when E = 255 and M > 0\end{matrix} \qquad ( 3 )$$

Therefore, the value range (which refers to the value range of the normal number) of FTF16 in FIG. 5 is [−0.996, 0.996].

Next, the advantages of the FTF16 format in one embodiment of the application are compared to conventional self-defined floating-point formats. The main focus is on the limitations of the value range and the impact of errors in exponent bits.

Regarding the limitation of the value range, the values in the FTF16 format are constrained to a smaller range (for example, but not limited to, between −1 and 1), which will be explained separately below. This means that the value range of the FTF16 format contributes to a more accurate representation of values within a specific range. In contrast, conventional self-defined floating-point formats have a larger value range, making it challenging to precisely represent values.

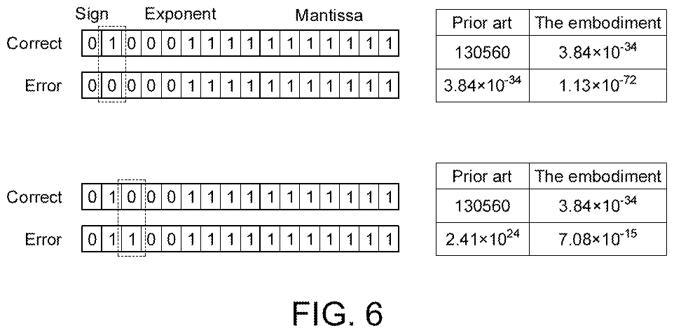

FIG. 6 compares the FTF16 format in one embodiment of the application with a known self-defined floating-point format in case that there are errors in exponent bits, to describe the effects caused by errors in exponent bits. When the exponent bits are correct, the FTF16 format in this embodiment is 3.84×10⁻³⁴, while the known self-defined floating-point format is 130560.

When there is an error in the last exponent bit, the FTF16 format in this embodiment becomes 1.13×10⁻⁷², whereas the known self-defined floating-point format is 3.84×10⁻³⁴. Similarly, with an error in the last second exponent bit, the FTF16 format in this embodiment is 7.08×10⁻¹⁵, while the known self-defined floating-point format becomes 2.41×10²⁴.

Therefore, as observed from FIG. 6 and the above, regarding the impact of errors in the exponent bits, the numerical variation in the known self-defined floating-point format is very large (from 130560 into 3.84×10⁻³⁴ and 2.41×10²⁴) when errors in the exponent bits occur. In comparison, when errors in the exponent bits occur, the numerical variation in the FTF16 format of this embodiment is very small (from 3.84×10⁻³⁴ into 1.13×10⁻⁷² and 7.08×10⁻¹⁵).

In summary, due to the smaller value range of the FTF16 format in this embodiment, it exhibits lower sensitivity to errors in exponent bits. This makes the FTF16 format in this embodiment more reliable in AI application scenarios, especially in situations demanding higher precision and stability.

In one embodiment of the application, the weights of neural network models can adopt the FTF format to reduce negative effects caused by bit errors, to enable CIM and enhance computational speed.

In another embodiment of the application, when the total number of bits for the exponent and mantissa is fixed, the number of bits for the exponent and mantissa can be adjusted, i.e., 1+X+Y=16, which is also within the scope of the application.

Even in other possible embodiments of the application, FTF16 can be extended to other total bit numbers, such as 1+X+Y=8, forming the FTF8 format.

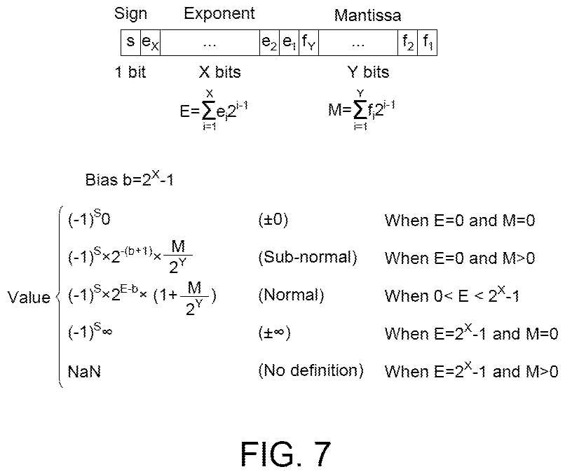

FIG. 7 illustrates the Fault-tolerant Floating Point (FTF) format in another embodiment of the application.

The multi-bit Fault-tolerant Floating Point (FTF) format includes a sign field (with one sign bit s), an exponent field (with X exponent bits e_{X}-e₁), and a mantissa field (with Y mantissa bits f_{Y}-f₁).

Representing the X exponent bits in decimal as E, E can be expressed as follows in Equation (4):

$$E = {\sum }_{i = 1}^{X} {e}_{i} {2}^{i - 1} \qquad ( 4 )$$

Representing the Y mantissa bits in decimal as M, M can be expressed as follows in Equation (5):

$$M = {\sum }_{i = 1}^{Y} {f}_{i} {2}^{i - 1} \qquad ( 5 )$$

Therefore, the numerical value of FTF is as follows.

When E=0 and M=0, FTF16 is given by FTF16=(−1)^{s}0. In this case, when the sign s=0, FTF16 is FTF16=(−1)⁰0=+0, and when s=1, FTF16 is FTF16=(−1)¹0=−0. Therefore, when E=0 and M=0, FTF16 is referred to as positive-negative zero (+0).

When E=0 and M>0, FTF16 is given by

$$FTF = {( - 1 )}^{s} \times {2}^{- ( b + 1 )} \times \frac{M}{{2}^{Y}} ,$$

and this is termed as a sub-normal value. The bias b is defined as: b=2^{X}−1.

When 0<E<2^{X}−1 (regardless of the value of M), FTF16 is given by

$$FTF = {( - 1 )}^{s} \times {2}^{E - b} \times ( 1 + \frac{M}{{2}^{Y}} ) ,$$

and this is termed as a normal value.

When E=2^{X}−1 and M=0, FTF16 is given by FTF16=(−1)^{s}∞, and this is termed as positive-negative infinity (too).

When E=2^{X}−1 and M>0, FTF16 is termed as a NaN (Not a Number).

Summarizing the above:

$$Value = \{ \begin{matrix}{( - 1 )}^{s} 0 ( \pm 0 ) when E = 0 and M = 0 \\ {( - 1 )}^{s} \times {2}^{- ( b + 1 )} \times \frac{M}{{2}^{Y}} ( sub - normal ) when E = 0 and M > 0 \\ {( - 1 )}^{s} \times {2}^{E - b} \times ( 1 + \frac{M}{{2}^{Y}} ) ( normal ) when 0 < E < {2}^{X} - 1 \\ {( - 1 )}^{s} ∞ ( \pm ∞ ) when E = {2}^{X} - 1 and M = 0 \\ NaN when E = {2}^{X} - 1 and M > 0\end{matrix}$$

In one embodiment of the application, FTT and FTF are designed to train neural network models on memory devices with unavoidable errors, such as NAND flash memory. The FTT and FTF in this embodiment can also be applied to other error sources, such as errors in high/low-temperature environments or errors caused by manufacturing defects.

Furthermore, although in the above embodiment, FTF16 is designed for 16-bit numbers with a value range within (−1, 1), such as weights in neural network models. In other possible embodiments of the application, the bias value in the general formula can be changed to represent values within different value ranges. As for the range of the bias value, as long as the ratio of the total number of values with an absolute value less than 1 to the total number of values with an absolute value greater than 1 is kept below 2, it can be considered a good range for the bias value.

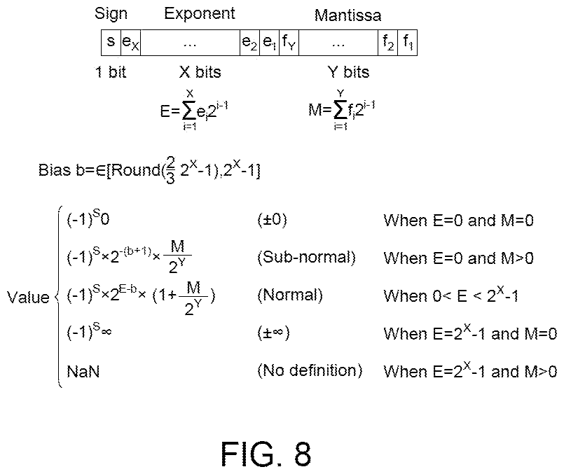

FIG. 8 illustrates another embodiment of the Fault-tolerant Floating Point (FTF) format in the application. The multi-bit Fault-tolerant Floating Point (FTF) format includes a sign field (with one sign bit s), an exponent field (with X exponent bits e_{X}-e₁), and a mantissa field (with Y mantissa bits f_{Y}-f₁). The range of the bias value b is:

$$b ∈ [ Round ( \frac{2}{3} {2}^{X} - 1 ) , {2}^{X} - 1 ] .$$

Here, Round is the rounding function. In other words, the range of the bias value b is determined by 2^{X}−1 and the rounded result of

$$\frac{2}{3} {2}^{X} - 1 , ( Round ( \frac{2}{3} {2}^{X} - 1 ) ) .$$

Therefore, the numerical value of FTF in FIG. 8 is as follows.

When E=0 and M=0, FTF16 is given by FTF16=(−1)^{s}0. In this case, when the sign s=0, FTF16 is FTF16=(−1)⁰0=+0, and when s=1, FTF16 is FTF16=(−1)¹0=−0. Therefore, when E=0 and M=0, FTF16 is referred to as positive-negative zero (+0).

When E=0 and M>0, FTF16 is given by

$$FTF = {( - 1 )}^{s} \times {2}^{- ( b + 1 )} \times \frac{M}{{2}^{Y}} ,$$

and this is termed as a sub-normal value.

When 0<E<2^{X}−1 (regardless of the value of M), FTF16 is given by

$$FTF = {( - 1 )}^{s} \times {2}^{E - b} \times ( 1 + \frac{M}{{2}^{Y}} ) ,$$

and this is termed as a normal value.

When E=2^{X}−1 and M=0, FTF16 is given by FTF16=(−1)^{s}∞, and this is termed as positive-negative infinity (±∞).

When E=2^{X}−1 and M>0, FTF16 is termed as a NaN (Not a Number).

Summarizing the above:

$$Value = \{ \begin{matrix}{( - 1 )}^{s} 0 ( \pm 0 ) when E = 0 and M = 0 \\ {( - 1 )}^{s} \times {2}^{- ( b + 1 )} \times \frac{M}{{2}^{Y}} ( sub - normal ) when E = 0 and M > 0 \\ {( - 1 )}^{s} \times {2}^{E - b} \times ( 1 + \frac{M}{{2}^{Y}} ) ( normal ) when 0 < E < {2}^{X} - 1 \\ {( - 1 )}^{s} ∞ ( \pm ∞ ) when E = {2}^{X} - 1 and M = 0 \\ NaN when E = {2}^{X} - 1 and M > 0\end{matrix}$$

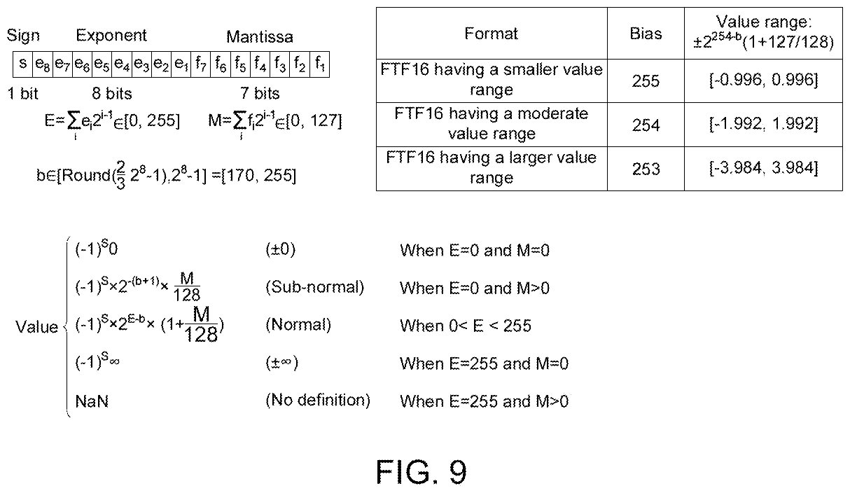

To illustrate the impact of setting the bias value b on the value range of FTF, please refer to FIG. 9. FIG. 9 depicts another Fault-tolerant Floating Point (FTF) format in one embodiment of the application.

The multi-bit Fault-tolerant Floating Point (FTF) format in FIG. 9 includes a sign field (with one sign bit s), an exponent field (with 8 exponent bits e₈-e₁), and a mantissa field (with 7 mantissa bits f₇-f₁). The range of the bias value b is:

$$∈ [ Round ( \frac{2}{3} {2}^{8} - 1 ) , {2}^{8} - 1 ] = [ 170 , 255 ] .$$

Therefore, the numerical value of FTF in FIG. 9 is as follows.

When E=0 and M=0, FTF16 is given by FTF16=(−1)^{s}0. In this case, when the sign s=0, FTF16 is FTF16=(−1)⁰0=+0, and when s=1, FTF16 is FTF16=(−1)¹0=−0. Therefore, when E=0 and M=0, FTF16 is referred to as positive-negative zero (+0).

When E=0 and M>0, FTF16 is given by

$$FTF = {( - 1 )}^{s} \times {2}^{- ( b + 1 )} \times \frac{M}{128} ,$$

and this is termed as a sub-normal value.

When 0<E<255 (regardless of the value of M), FTF16 is given by

$$FTF = {( - 1 )}^{s} \times {2}^{E - b} \times ( 1 + \frac{M}{128} ) ,$$

and this is termed as a normal value.

When E=255 and M=0, FTF16 is given by FTF16=(−1)^{s}∞, and this is termed as positive-negative infinity (±∞).

When E=255 and M>0, FTF16 is termed as a NaN (Not a Number).

Summarizing the above:

$$Value = \{ \begin{matrix}{( - 1 )}^{s} 0 ( \pm 0 ) when E = 0 and M = 0 \\ {( - 1 )}^{s} \times {2}^{- ( b + 1 )} \times \frac{M}{128} ( sub - normal ) when E = 0 and M > 0 \\ {( - 1 )}^{s} \times {2}^{E - b} \times ( 1 + \frac{M}{128} ) ( normal ) when 0 < E < 255 \\ {( - 1 )}^{s} ∞ ( \pm ∞ ) when E = 255 and M = 0 \\ NaN when E = 255 and M > 0\end{matrix}$$

The value range of the Fault-tolerant Floating Point (FTF) is given by ±2^{254-b}(1+127/128).

When the bias value b is 255, the FTF value range is [−0.996, 0.996], indicating a smaller value range. When the bias value b is 254, the FTF value range is [−1.992, 1.992], representing a moderate value range. When the bias value b is 253, the FTF value range is [−3.984, 3.984], showing a larger value range. In other words, as the bias value increases, the FTF value range decreases, and vice versa.

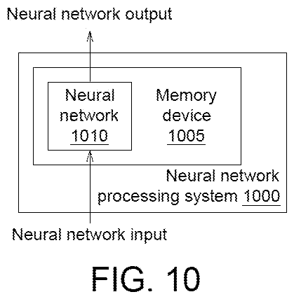

FIG. 10 illustrates an example of a neural network processing system 1000 based on one embodiment of the present application. The neural network processing system 1000 is an example of a system implemented as a computer program on one or more computers at one or more locations.

The system includes one or more memory devices 1005 storing a neural network 1010. The neural network 1010 has one or more neural network models. When training one or more of these neural network models, the memory device 1005 executes the fault-tolerant training method described above. Additionally, the neural network 1010 can be compatible with the Fault-tolerant Floating Point (FTF) format of another embodiment of the application, such as representing input values, weight values, and output values in FTF.

The neural network processing system 1000 is designed for performing neural network calculations using floating-point arithmetic.

Floating-point arithmetic refers to performing calculations using floating-point data types. The neural network 1010 is an example of a neural network that can be configured to receive any type of digital data input and generate any type of score or classification output based on the digital data input.

The neural network 1010 includes multiple neural network layers, including one or more input layers, one output layers, and one or more hidden layers. Each neural network layer includes one or more neural network nodes, and each node has one or more weight values. Each node processes a series of input values using the respective weight values and performs operations on the processing result to generate an output value.

In some implementations, each node of the input layer of the neural network 1010 receives a set of floating-point input values. The output values are the values generated by the output layer nodes of the neural network 1010 when processing the neural network input.

The generated neural network output can be stored in an output database or provided for other purposes, such as displaying on user devices or further processing by another system.

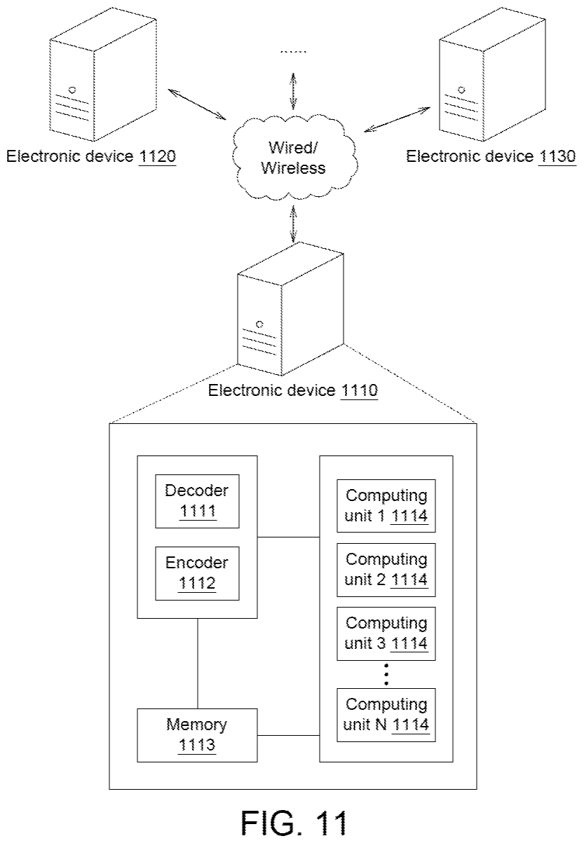

Refer to FIG. 11, which is a schematic diagram of a system architecture provided in one embodiment of the application. The technical solution of the embodiment described above can be specifically implemented in a system architecture similar to the one shown in FIG. 11. As shown in FIG. 11, the system architecture may include multiple electronic devices, such as electronic device 1110, electronic device 1120, and electronic device 1130, for example. Communication connections between electronic device 1110, electronic device 1120, and electronic device 1130 can be established through wired or wireless networks (such as Wi-Fi, Bluetooth, and mobile networks), enabling data storage, computation, and transmission based on floating-point numbers in various fields (finance, engineering, scientific research, aerospace, etc.).

In the example of electronic device 1110, the electronic device 1110 includes a decoder 1111 and an encoder 1112 for floating-point processing, a memory 1113, and multiple computing units 1114 (such as computing unit 1, computing unit 2, computing unit 3, . . . , computing unit N). When electronic device 1110 performs general computing, high-performance computing, or AI training, a large number of floating-point data may be required. The electronic device can use the decoder 1111, based on the floating-point processing method provided in one embodiment of the application, to obtain the corresponding floating-point data (which can be obtained from the local memory 1113 or from electronic devices 1120 or 1130 through wired or wireless networks), and transmit this floating-point data to the computing units to complete the corresponding calculation. Similarly, the final results obtained by the computing units can be encoded into floating-point numbers by the encoder 1112, which can be used for data storage and transfer. In this way, one embodiment of the application can flexibly meet different requirements for the value range and precision of floating-point numbers in various scenarios (such as general computing, high-performance computing, or AI training) without increasing the total number of bits, that is, without additional data storage or transfer costs.

In FIG. 11, the structure and functions of electronic devices 1120 and electronic devices 1130 can refer to electronic device 1110. In some possible implementations, electronic devices 1110, 1120, and 1130 may include more or fewer components than shown in FIG. 11. This embodiment of the present application does not specifically limit this.

In summary, electronic devices 1110, 1120, and 1130, having the above functions, can be smart wearable devices, smartphones, smart home appliances, tablets, laptops, desktop computers, in-car computers, or servers, which can be a single server, a server cluster composed of multiple servers, or a cloud computing service center, etc. This embodiment of the present application does not specifically limit this.

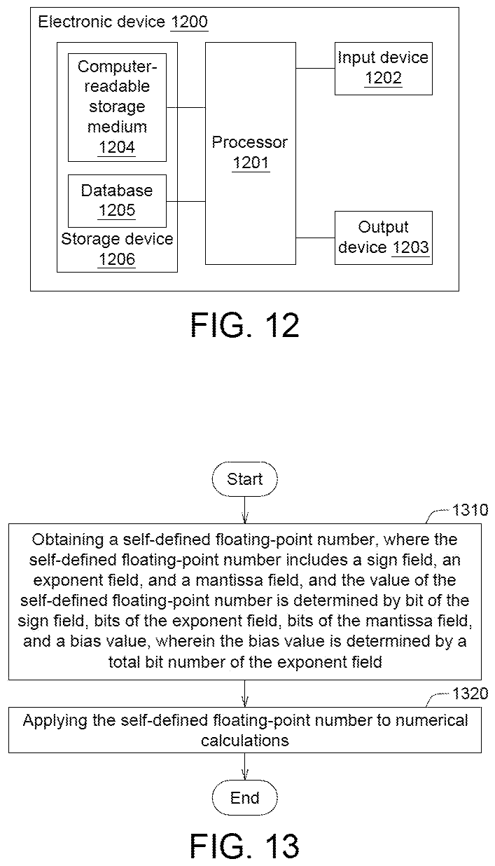

Based on the description of the method and device embodiments above, one embodiment of the application case also provides an electronic device. FIG. 12 is a schematic diagram of the structure of an electronic device provided in one embodiment of the application. As shown in FIG. 12, the electronic device 1200 includes at least a processor 1201, an input device 1202, an output device 1203, and a storage device 1206. The storage device 1206 includes a computer-readable storage medium 1204 and a database 1205. The electronic device 1200 may further include other common components, which are not described in detail here. Among them, the processor 1201, the input device 1202, the output device 1203, and the computer-readable storage medium 1204 are connected via a bus or other means. The electronic device 1200 can implement the electronic devices 1110, 1120, and 1130 shown in FIG. 11.

The processor 1201 can be a general-purpose central processing unit (CPU), microprocessor, application-specific integrated circuit (ASIC), or one or more integrated circuits used to control the execution of instructions in the above embodiments. The processor 1201 can execute the fault-tolerant training method described in the above embodiments. Additionally, the processor 1201 can be compatible with the Fault-tolerant Floating Point (FTF) format described in another embodiment of the application. Moreover, the processor 1201 can execute the floating-point processing method described in another embodiment of the application.

The memory in the electronic device 1200 can be read-only memory (ROM) or another type of static storage device capable of storing static information and instructions, random access memory (RAM), or another type of dynamic storage device capable of storing information and instructions. Additionally, the memory can be Electrically Erasable Programmable Read-Only Memory (EEPROM), Compact Disc Read-Only Memory (CD-ROM), or other optical disk storage, magnetic disk storage, or other magnetic storage device, or any other medium capable of carrying or storing code in the form of instructions or data structures and accessible by a computer. The memory may be independent or connected to the processor by a bus. The memory can also be integrated with the processor.

The computer-readable storage medium 1204 may store a computer program that includes program instructions. When the processor 1201 executes the program instructions stored in the computer-readable storage medium 1204, the processor 1201 can perform any part or all of the steps described in any of the embodiments of the application.

The application also provides a computer-readable storage medium, where the computer-readable storage medium can store a program, and when the program is executed by the processor, the processor can perform any part or all of the steps described in any of the embodiments of the application.

The application also provides a computer program that includes instructions. When the computer program is executed by a processor, the processor can perform any part or all of the steps described in any of the embodiments of the application.

FIG. 13 illustrates a floating-point processing method applied to an electronic device according to one embodiment of the application. The floating-point processing method includes: (1310) obtaining a self-defined floating-point number, where the self-defined floating-point number includes a sign field, an exponent field, and a mantissa field, and the value of the self-defined floating-point number is determined by bit of the sign field, bits of the exponent field, bits of the mantissa field, and a bias value, wherein the bias value is determined by a total bit number of the exponent field; and (1320) applying the self-defined floating-point number to numerical calculations.

In another embodiment of the application, a floating-point arithmetic method is disclosed. The method includes receiving a request to perform floating-point arithmetic using a neural network, where the neural network includes multiple weights, and these weights have a self-defined Fault-tolerant Floating Point (FTF) format; and receiving a neural network input, and the neural network uses the neural network and the weights to obtain a neural network output.

In summary, the Fault-tolerant Training (FTT) of one embodiment of the application is a training process designed to train neural network models in the presence of errors in the environment. The core concept is to train in the presence of errors without sacrificing accuracy. This means that the FTT of one embodiment of the application aims to enable neural network models to maintain robustness and performance in the presence of inevitable environmental errors.

The Fault-tolerant Floating Point (FTF) format of another embodiment of the application can be applied to the weights of neural network models, restricting the value range within an effective range of the weights. The core concept is to efficiently use every bit of the weights while reducing the impact of exponent bit errors. The goal of the FTF format of another embodiment of the application is to reduce numerical uncertainty caused by memory errors while maintaining performance.

The above embodiments can be applied to memory devices that support specialized Multiply Accumulate (MAC) operations with FTF format, including but not limited to DRAM, NVM, etc.

While this document may describe many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination in some cases can be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few examples and implementations are disclosed. Variations, modifications, and enhancements to the described examples and implementations and other implementations can be made based on what is disclosed.

What is claimed is:

1. A neural network system comprising one or more memory devices, wherein the one or more memory devices store one or more neural network models, and when training the one or more neural network models, the one or more memory devices executing:
initiating weight training iterations;
determining whether an abnormal weight is detected;
when the abnormal weight is detected, setting the abnormal weight to a reference value; and
when no abnormal weights are detected, proceeding to the next training iteration.

2. The neural network system of claim 1, wherein, when determining whether the abnormal weight is detected, checking whether at least one of an updated weight and a pre-update weight is abnormal.

3. The neural network system of claim 1, wherein, when a weight exceeds a range of a median of normal weights plus or minus one or more standard deviations, the weight is determined to be abnormal.

4. The neural network system of claim 1, wherein, when a weight exceeds a value range, the weight is determined to be abnormal, and the value range depends on a self-defined floating-point format.

5. The neural network system of claim 1, wherein, the reference value is a median of a plurality of normal weights.

6. The neural network system of claim 1, wherein, the reference value is zero.

7. A floating-point processing method applied to an electronic device, the floating-point processing method comprising:
obtaining a self-defined floating-point number, wherein the self-defined floating-point number comprises a sign field, an exponent field, and a mantissa field, and a value of the self-defined floating-point number is determined by bit of the sign field, bits of the exponent field, bits of the mantissa field, and a bias value, wherein the bias value is determined by a total bit number of the exponent field; and
applying the self-defined floating-point number to numerical calculations.

8. The floating-point processing method of claim 7, wherein
the exponent field includes X exponent bits, the mantissa field includes Y mantissa bits, X and Y are positive integers;
when an exponent field value E and a mantissa field value M are both 0, the value of the self-defined floating-point number is positive-negative zero;
when the exponent field value E is 0 and the mantissa field value M is greater than 0, the value of the self-defined floating-point number is:
$${( - 1 )}^{s} \times {2}^{- ( b + 1 )} \times \frac{M}{{2}^{Y}} ,$$
where b is the bias value, and s represents a sign bit of the sign field;
when 0<E<2^{X}−1, the value of the self-defined floating-point number is
$${( - 1 )}^{s} \times {2}^{E - b} \times ( 1 + \frac{M}{{2}^{Y}} ) ,$$
and the value of the self-defined floating-point number is a normal value;
when E=2^{X}−1 and M=0, the value of the self-defined floating-point number is positive-negative infinity; and
when E=2^{X}−1 and M>0, the value of the self-defined floating-point number is not a number (NaN).

9. The floating-point processing method of claim 8, wherein relationship between the bias value and the total bit number of the exponent field is: b=2^{X}−1.

10. The floating-point processing method of claim 8, wherein relationship between the bias value and the total bit number of the exponent field is:
$$b ∈ [ Round ( \frac{2}{3} {2}^{X} - 1 ) , {2}^{X} - 1 ] ,$$
where Round is a rounding function.

11. The floating-point processing method of claim 8, wherein, as the bias value increases, a value range of the self-defined floating-point number decreases.

12. A floating-point processing device comprising a processor, the processor executing:
obtaining a self-defined floating-point number, wherein the self-defined floating-point number comprises a sign field, an exponent field, and a mantissa field, and a value of the self-defined floating-point number is determined by bit of the sign field, bits of the exponent field, bits of the mantissa field, and a bias value, wherein the bias value is determined by a total bit number of the exponent field; and
applying the self-defined floating-point number to numerical calculations.

13. The floating-point processing device of claim 12, wherein
the exponent field includes X exponent bits, the mantissa field includes Y mantissa bits, X and Y are positive integers;
when an exponent field value E and a mantissa field value M are both 0, the value of the self-defined floating-point number is positive-negative zero;
when the exponent field value E is 0 and the mantissa field value M is greater than 0, the value of the self-defined floating-point number is:
$${( - 1 )}^{s} \times {2}^{- ( b + 1 )} \times \frac{M}{{2}^{Y}} ,$$
where b is the bias value, and s represents a sign bit of the sign field;
when 0<E<2^{X}−1, the value of the self-defined floating-point number is
$${( - 1 )}^{s} \times {2}^{E - b} \times ( 1 + \frac{M}{{2}^{Y}} ) ,$$
and the value of the self-defined floating-point number is a normal value;
when E=2^{X}−1 and M=0, the value of the self-defined floating-point number is positive-negative infinity; and
when E=2^{X}−1 and M>0, the value of the self-defined floating-point number is not a number (NaN).

14. The floating-point processing device of claim 13, wherein relationship between the bias value and the total bit number of the exponent field is: b=2^{X}−1.

15. The floating-point processing device of claim 13, wherein relationship between the bias value and the total bit number of the exponent field is:
$$b ∈ [ Round ( \frac{2}{3} {2}^{X} - 1 ) , {2}^{X} - 1 ] ,$$
where Round is a rounding function.

16. The floating-point processing device of claim 13, wherein, as the bias value increases, a value range of the self-defined floating-point number decreases.
